(19) United States
(12) Patent Application Publication
(10) Pub. No.: US 2025/0238267 A1
(43) Pub. Date: Jul. 24, 2025

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Hiroshi ABE, Kasukabe-shi (JP); Koji TAKEOKA, Yokohama-shi (JP); Kiichi IWASAKI, Nagoya-shi (JP); Takayuki SAKAI, Setagaya-ku (JP); Isao NISHIOKA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 19/027,392

(22) Filed: Jan. 17, 2025

(30) Foreign Application Priority Data
Jan. 24, 2024 (JP) 2024-008713

(51) Int. Cl. G06F 9/50

(52) U.S. Cl. CPC G06F 9/5027

(57) ABSTRACT

An information processing device comprises a control unit that acquires information indicating each of a first computing resource and a second computing resource that are collectively-managed computing resources, the first computing resource being provided in each of one or more vehicles, the second computing resource being a computing resource placed within a network, and outputs information indicating a computing resource for providing a service to a target vehicle, the computing resource being selected from among the first computing resource and the second computing resource, wherein each of the one or more vehicles is in a parked state and in a charging state where a secondary cell that supplies power to a motor provided in each of the one or more vehicles is being charged.

### CROSS REFERENCE TO THE RELATED APPLICATION

This application claims the benefit of Japanese Patent Application No. 2024-008713, filed on Jan. 24, 2024, which is hereby incorporated by reference herein in its entirety.

### BACKGROUND

### Technical Field

The present disclosure relates to an information processing device, an information processing method, and a non-transitory storage medium.

### Description of the Related Art

Task execution methods for determining which vehicles, among a plurality of vehicles, are caused to perform specified task processing on the basis of predicted execution end times have been known (for example, Japanese Patent Application Laid-open No. 2017-129921).

### SUMMARY

It is an object of the present disclosure to provide a technology that allows the suitable selection of computing resources for providing a service to a target vehicle.

An aspect of the present disclosure provides an information processing device including: a control unit that acquires information indicating each of a first computing resource and a second computing resource that are collectively-managed computing resources, the first computing resource being provided in each of one or more vehicles, the second computing resource being a computing resource placed within a network, and outputs information indicating a computing resource for providing a service to a target vehicle, the computing resource being selected from among the first computing resource and the second computing resource, wherein each of the one or more vehicles is in a parked state and in a charging state where a secondary cell that supplies power to a motor provided in each of the one or more vehicles is being charged.

Another aspect of the present disclosure provides an information processing method including: acquiring, by an information processing device, information indicating each of a first computing resource and a second computing resource that are collectively-managed computing resources, the first computing resource being provided in each of one or more vehicles, the second computing resource being a computing resource placed within a network; and outputting, by the information processing device, information indicating a computing resource for providing a service to a target vehicle, the computing resource being selected from among the first computing resource and the second computing resource, wherein each of the one or more vehicles is in a parked state and in a charging state where a secondary cell that supplies power to a motor provided in each of the one or more vehicles is being charged.

Another aspect of the present disclosure provides a non-transitory computer-readable storage medium storing a program that causes a computer to: acquire information indicating each of a first computing resource and a second computing resource that are collectively-managed computing resources, the first computing resource being provided in each of one or more vehicles, the second computing resource being a computing resource placed within a network; and output information indicating a computing resource for providing a service to a target vehicle, the computing resource being selected from among the first computing resource and the second computing resource, wherein each of the one or more vehicles is in a parked state and in a charging state where a secondary cell that supplies power to a motor provided in each of the one or more vehicles is being charged.

Another aspect of the present disclosure may include an information processing system including the information processing device described above, or the like.

According to the present disclosure, it is possible to suitably select computing resources for providing a service to a target vehicle.

### BRIEF DESCRIPTION OF THE DRAWINGS

FIG. 1 is a diagram illustrating a configuration example of an information processing system;

FIG. 2A is a diagram illustrating a configuration example of an information processing device (server), and FIG. 2B is a diagram illustrating a configuration example of an information processing device (terminal) mounted in a vehicle;

FIG. 3 is a function block diagram of a management server;

FIG. 4A is a diagram illustrating a data structure example of a network database (network DB), FIG. 4B is a diagram illustrating a data structure example of a management database (management DB), and FIG. 4C is a diagram illustrating a data structure example of a management database (management DB);

FIG. 5 is a sequence diagram illustrating a processing example in the information processing system; and

FIG. 6 is a flowchart illustrating a processing example related to the redistribution of computing resources.

### DESCRIPTION OF THE EMBODIMENTS

Hereinafter, an embodiment of the present disclosure will be described with reference to the drawings. Note that in all the drawings of the following embodiment, the same or corresponding components will be denoted by the same symbols. Further, the present disclosure is not limited to the embodiment that will be described below.

Constituting elements in the following embodiment include those that are replaceable and easily obtained by persons skilled in the art, as well as those that are substantially the same.

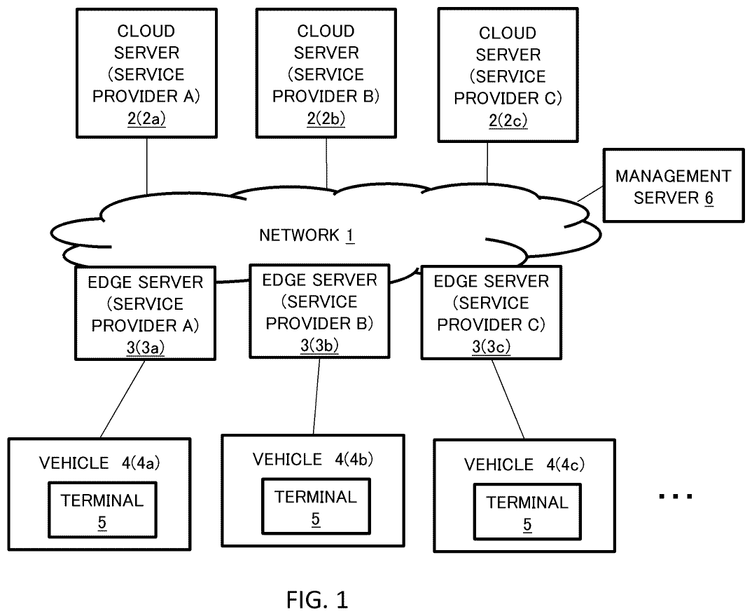

Information Processing System FIG. 1 is a diagram illustrating a configuration example of an information processing system. In FIG. 1, the information processing system includes a network 1, a plurality of cloud servers 2, a plurality of edge servers 3, and a management server 6. Further, the information processing system also includes vehicles 4 having terminals 5 capable of communicating with the cloud servers 2 or the edge servers 3 via the network 1.

The network 1 is, for example, a public communication network such as the Internet. The cloud servers 2, the edge servers 3, the management server 6, and the terminals 5 are connected to each other via a wired or wireless access network (including a cellular network). A wireless communication network serving as an access network to the network 1 conforms to or complies with a wireless communication standard usable by the terminals 5. The wireless communication standard includes, for example, 4G (Long Term Evolution (LTE)), 5G, a wireless Local Area Network (LAN: including Wi-Fi), BLE, or the like but may include other standards.

Upon receiving requests from the terminals 5, the cloud servers 2 provide services (such as services to provide various information) for the vehicles 4 in which the terminals 5 are mounted. The information includes, for example, information requested by the terminals 5, information that is to be transmitted to the terminals 5 according to a specified trigger, information indicating the analysis results of information obtained from the terminals 5, or the like. The information may also include traffic information, information indicating the surrounding environments of the vehicles 4, emergency information such as earthquakes, or the like. However, any type of services may be provided in the present disclosure.

When the edge servers 3 are closer to the vehicles 4 than the cloud servers 2, they exchange information or data with the terminals 5 instead of the cloud servers 2. One or two or more edge servers 3 may be responsible for one cloud server 2.

In FIG. 1, each of a plurality of service providers has a cloud server 2 and an edge server 3. In FIG. 1, three service providers A, B, and C are exemplified as the plurality of service providers. The service provider A has a cloud server 2a and an edge server 3a, the service provider B has a cloud server 2b and an edge server 3b, and the service provider C has a cloud server 2c and an edge server 3c. However, the respective service providers may have any number of cloud servers 2 and edge servers 3 that substitute for the cloud servers 2.

The vehicles 4 are Electric Vehicles (EVs), and include a motor that drives driving wheels and a secondary cell (that may be referred also to as a storage cell or a charging cell) that supplies driving power to the motor. The EVs include Plug-in Hybrid Vehicles (PHEVs), Fuel Cell Vehicles (FCVs), Battery Electric Vehicles (BEVs), or the like.

The terminals 5 establish connections with the cloud servers 2 or the edge servers 3, and receive services through the transmission and reception of data. Prior to receiving services, the terminals 5 transmit messages requesting the services (referred to as service request messages) to the management server 6.

The management server 6 collectively manages the computing resources of the cloud servers 2 and the edge servers 3 of two or more service providers (the service providers A, B, and C in FIG. 1), as well as the computing resources of the vehicles 4 (referred to as registered vehicles) registered as computing resource providers.

The cloud servers 2, the edge servers 3, and the vehicles 4 (including the terminals 5) have computing resources for performing computing (computer processing) to provide services to the vehicles 4 (referred to as target vehicles) to which the services are to be provided. The computing resources include a processor such as a Central Processing Unit (CPU), a memory (main storage device) used by the CPU to run programs, an auxiliary storage device (such as a hard disk) that stores programs or data, or the like.

The management server 6 collectively manages the computing resources of the cloud servers 2, the edge servers 3, and the vehicles 4 (including the terminals 5) of a plurality of entities (service providers and vehicle users), and uses the computing resources to provide services to target vehicles. The computing resources of the vehicles 4 illustrate an example of “first computing resources,” while the computing resources of the cloud servers 2 and the edge servers 3 illustrate an example of “second computing resources that are computing resources placed within a network.” Further, the second computing resources may include the computing resources of servers (for example, the management server 6) other than the cloud servers 2 and the edge servers 3. When the cloud servers 2, the edge servers 3, and the servers other than the cloud servers 2 and the edge servers 3 will be collectively referred to in the following description, they will be mentioned as “servers.”

By using the computing resources (first computing resources) of registered vehicles, it is possible to increase the amount of computing resources compared to a case where only the second computing resources are used. However, the computing resources of vehicles used as the first computing resources are limited to the computing resources of the vehicles 4 that are in a parked state and in a charging state where a secondary cell that supplies power to a motor is being charged. This is because the amount of computing resources usable in a parked state is expected to be greater than the amount of computing resources usable in states (such as a traveling state) other than the parked state. In addition, it is expected that the transmission and reception of data related to processing is stabilized when vehicles are in a parked state (i.e., a fixed position).

Upon receiving service request messages from the terminals 5, the management server 6 allocates computing resources corresponding to provided services (distributes computing resources to target vehicles). In accordance with the allocation results of the computing resources, the management server 6 provides instructions to the cloud servers 2, the edge servers 3, other servers, and the vehicles 4 that serve as computing resource providers. The instructions include instructions to secure (task scheduling) the execution environments (the capacities of main storage devices and auxiliary storage devices and CPU times) of processing (tasks) related to service provision and task executing instructions. The instructions may also include processing times, and the computing resources may be secured (scheduled) so that the tasks are completed within the processing times. The computing resource providers having received the instructions secure the execution environments of the tasks and execute the tasks in accordance with the instructions.

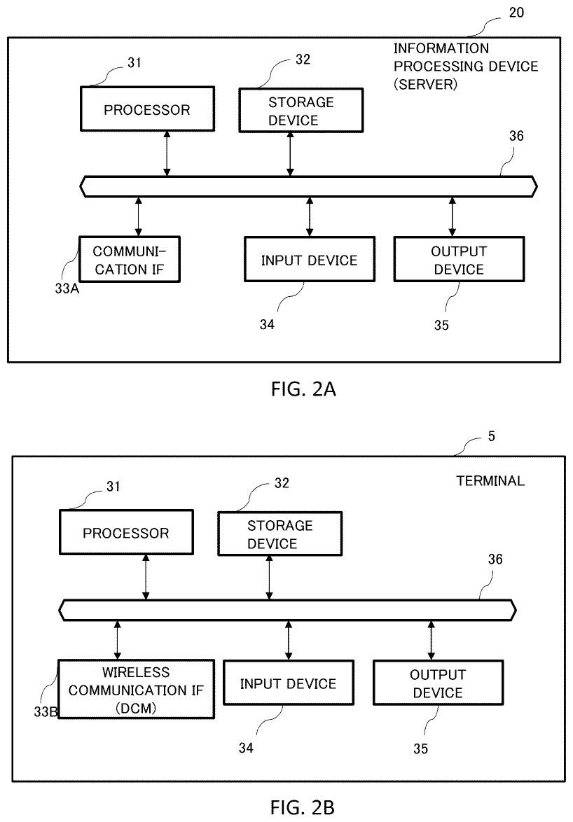

Configuration of Information Processing Device FIG. 2A is a diagram illustrating a configuration example of an information processing device 20 (referred to as a server 20) capable of operating as a cloud server 2, an edge server 3, or a management server 6. The information processing device (server) 20 may be configured using a general-purpose computer such as a personal computer (PC) and a workstation (WS) or a dedicated computer such as a server machine. The server 20 has a communication function and is capable of connecting to the network 1 in a wired or wireless fashion. The server 20 may be a single computer or an aggregate of two or more computers.

In FIG. 2A, the server 20 includes a processor 31 serving as a processing unit or a control unit (controller), a storage device 32, a communication interface (communication IF) 33A, an input device 34, and an output device 35, all of which are connected to one another via a bus 36.

The storage device 32 includes a main storage device and an auxiliary storage device. The main storage device is used as a storage area for programs and data, a deployment area for programs, a work area for programs, a buffer area for communication data, or the like. The main storage device is composed of a Random Access Memory (RAN) or a combination of a RAM and a Read-Only Memory (ROM). The auxiliary storage device is used as a storage area for data and programs. As the auxiliary storage device, a non-volatile storage medium such as a hard disk, a Solid State Drive (SSD), a flash memory, and Electrically Erasable Programmable Read-Only Memory (EEPROM) is applicable.

The communication IF 33A is a circuit that performs communication processing, and operates as a transmission unit and a reception unit (communication unit). For example, the communication IF 33A is a circuit that performs wired connection or wireless connection (such as LTE, 5G, wireless LAN (Wi-Fi), and BLE). The communication IF 33A is, for example, a network interface card (NIC).

The input device 34 includes a key, a button, a pointing device, a touch panel, or the like and is used for the input of information. The input device 34 may also include a microphone (sound input device). The output device 35 may be, for example, a liquid-crystal display, an organic EL display, or the like and displays information and data. The output device 35 may also include a speaker (sound output device).

The processor 31 is, for example, a CPU or the like. The processor 31 performs various processing by running various programs stored in the storage device 32.

FIG. 2B is a diagram illustrating a configuration example of a terminal 5. The terminal 5 may be a terminal installed in a vehicle 4 or a mobile terminal owned by a driver of the vehicle 4. The mobile terminal is, for example, a personal computer (PC), a smartphone, a tablet terminal, or the like.

In FIG. 2B, the terminal 5 includes a processor 31 serving as a processing unit or a control unit (controller), a storage device 32, a wireless communication interface (wireless communication IF) 33B, an input device 34, and an output device 35, all of which are connected to one another via a bus 36. The processor 31, the storage device 32, the input device 34, and the output device 35 of the terminal 5 are the same as those of the server 20, but they may have different performance or storage capacities. The wireless communication IF 33B is a circuit that performs wireless communication according to a specified wireless communication standard. The wireless communication IF 33B may include a communication device referred to as a Data Communication Module (DCM).

Note that a plurality of CPUs or a multi-core CPU may be applied as the processor 31 described above. At least some of the processing performed by the CPU may be performed by a processor other than the CPU, such as a Digital Signal Processor (DSP) and a Graphical Processing Unit (GPU). Further, at least some of the processing performed by the CPU may be performed by a dedicated or general-purpose integrated circuit (hardware). The integrated circuit includes an Application Specific Integrated Circuit (ASIC), a Field Programmable Gate Array (FPGA), or the like. Alternatively, at least some of the processing performed by the CPU may be performed by a combination of a processor and an integrated circuit. The combination is referred to as, for example, a Microcontroller (MCU), a System-on-a-chip (SoC), a system LSI, a chipset, or the like. Each of the above processor 31, the integrated circuit, and the combination is an example of circuitry.

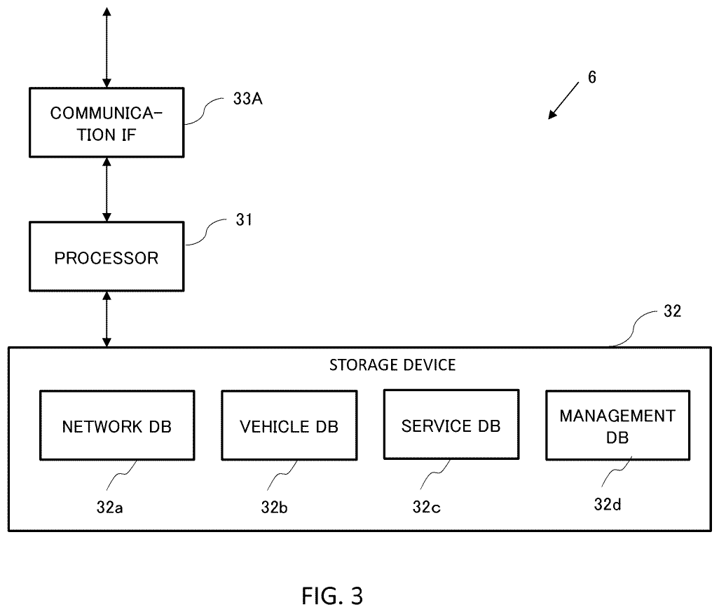

FIG. 3 is a diagram illustrating a configuration example of the management server 6. The server 20 is capable of operating as the management server 6 including the communication IF 33A, the processor 31, and the storage device 32 when the processor 31 runs a program stored in the storage device 32 or the like.

In the storage device 32, a network DB 32a, a vehicle DB 32b, a service database (service DB) 32c, and a management database (management DB) 32d are stored.

The network DB 32a stores information on various servers (the cloud servers 2, the edge servers 3, and other servers) that serve as computing resource providers.

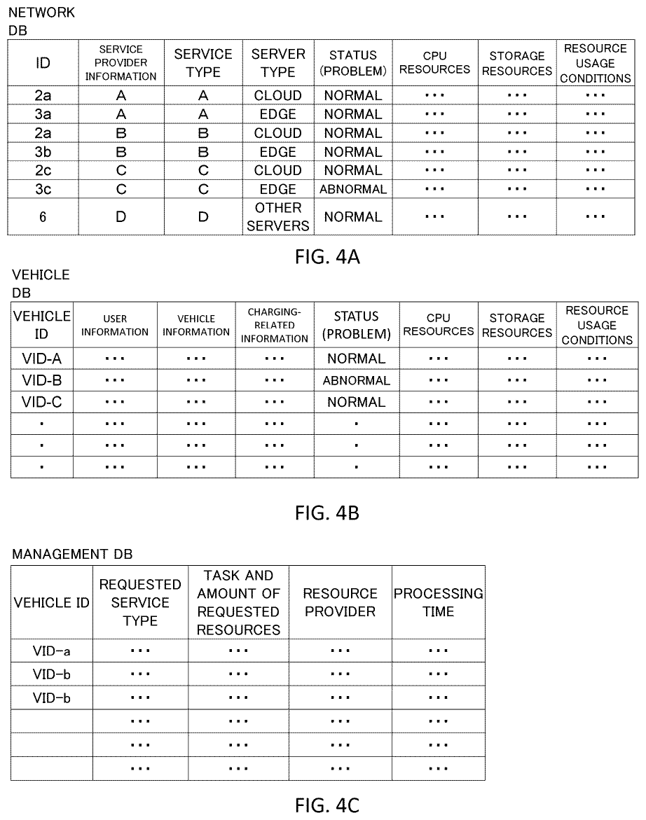

FIG. 4A illustrates a data structure example of the network DB 32a. The network DB 32a has a table structure made up of records (entries) for each of servers. The entries include “ID,” “service provider information,” “service type,” “server type,” “status (problem),” “CPU resources,” “storage resources,” and “resource usage conditions.”

As “IDs,” IDs indicating identification information inherent in respective servers is stored. As “service provider information,” information related to service providers that operate or manage servers is stored. As “service types,” information indicating the types of services provided by servers is stored. As “statuses (problems),” information (for example, “normal” or “abnormal”) indicating the presence or absence of problems, such as device problems and communication problems in servers, is stored. As “CPU resources,” information indicating CPU performance (for example, a computing amount per unit time) is stored. As “resource usage conditions,” information indicating the usage conditions of computing resources, such as the usage amounts of main storage devices, the usage amounts (usage rates) of auxiliary storage devices, CPU usage rates, and data transfer amounts is stored.

In the vehicle DB 32b, information related to registered vehicles is stored. FIG. 4B is a diagram illustrating a data structure example of the vehicle DB 32b. The vehicle DB 32b has a table structure made up of records (entries) for each of registered vehicles registered as computing resource providers. The entries include “vehicle ID,” “user information,” “vehicle information,” “charging-related information,” “status (problem),” “CPU resources,” “storage resources,” and “resource usage conditions.”

As “vehicle IDs,” vehicle IDs indicating identification information inherent in registered vehicles are stored. As “user information,” information related to the managers (owners) of registered vehicles, such as the users (owners) of registered vehicles, is stored. As “vehicle information,” information related to registered vehicles is stored. As “charging-related information,” information indicating that registered vehicles are in a parked state and being charged (in a charging state) and information indicating scheduled charging completion times are stored. As “CPU resources,” “storage resources,” and “resource usage conditions,” information indicating CPU resources, storage resources, and resource usage conditions related to registered vehicles is stored.

In the service DB 32c, information indicating service types, information indicating one or two or more tasks for providing services, information indicating the amounts of computing resources for performing respective tasks, and the like are stored.

In the management DB 32d, information indicating computing resources for providing services to target vehicles is stored. FIG. 4C illustrates a data structure example of the management DB 32d. The management DB 32d has a table structure made up of records (entries) for each of target vehicles. The entries include “vehicle ID,” “requested service type,” “amount of requested resources,” “resource provider,” and “processing time.”

As “vehicle IDs,” vehicle IDs indicating identification information inherent in target vehicles are stored. As “requested service types,” information indicating the types of services (referred to as requested services) requested (desired) by target vehicles is stored. Further, as “amounts of requested resources,” information indicating tasks for providing requested services and the amounts of computing resources for tasks is stored.

As “resource providers,” information indicating servers and vehicles providing computing resources, information indicating the amounts of computing resources (CPU resources and storage resources) provided by servers and vehicles, and the like are stored. As “processing times,” information indicating task processing times (computing resource providing (lending) times), such as task start times and scheduled task completion times, is stored.

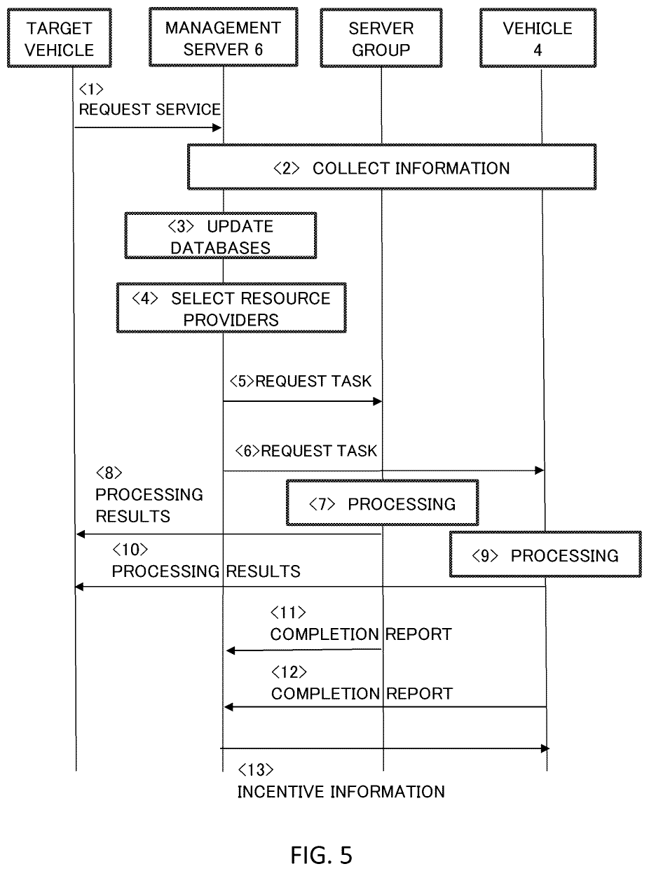

FIG. 5 is a sequence diagram illustrating a processing example in the information processing system. In FIG. 5, a target vehicle transmits a service request message to the management server 6 (<1> in FIG. 5). Upon receiving the service request message, the management server 6 collects various information including information related to computing resources from a server group (the cloud servers 2, the edge servers 3, and other servers) and the vehicles 4 that may provide computing resources (<2> in FIG. 5).

The management server 6 stores the collected information in the network DB 32a and the vehicle DB 32b, and updates these DBs (<3> in FIG. 5). That is, the processor 31 of the management server 6 accesses the service DB 32c using a service type contained in the received service request message. The processor 31 reads (acquires) a task and the amount of computing resources corresponding to the service type, that is, information indicating a task and the amount of requested resources for providing a service from the service DB 32c. The processor 31 stores information indicating the vehicle ID of the target vehicle and the service type contained in the service request message, as well as the information indicating the task and the amount of the requested resources read from the service DB 32c, in vacant entries of the management DB 32d to be associated with each other.

The processor 31 of the management server 6 selects the computing resources to be allocated to the task from the server group and the vehicles 4 that are in a parked and charging state, on the basis of the task and the amount of the requested resources related to the target vehicle stored in the management DB 32d and the information stored in the network DB 32a and the vehicle DB 32b (<4> in FIG. 5). At this time, the processor 31 performs the selection so that the servers and the vehicles 4 are included in the selection result of computing resource providers. However, there is a possibility that the vehicles 4 are not included in the selection result (one or two or more servers are selected) or that the servers are not included in the selection result (only one or two or more vehicles 4 are selected).

Any selection method may be employed, but it is preferable to select computing resources on the basis of the usage conditions of the computing resources of the servers and the vehicles 4. For example, the selection may also be performed so as to prevent biases from occurring between the service providers. Further, selection priorities may also be determined in advance for the servers and the vehicles 4. For example, the servers or the vehicles 4 may also be selected in descending order of the amount of computing resources capable of being provided. Further, the vehicles 4 may also be selected in order of the latest scheduled charging completion time. In the selection, the processor 31 refers to the network DB 32a and the vehicle DB 32b, and excludes servers and vehicles whose “status (problem)” indicates abnormality, that is, servers and vehicles that are in a problematic state, from the selection candidates. Further, the processor 31 excludes vehicles that are in a traveling state and are not being charged (in a non-charging state) among the vehicles 4 from the selection candidates. Moreover, vehicles 4 whose time until the scheduled charging completion time is shorter than a threshold may also be excluded from the selection candidates. Further, servers and vehicles 4 whose (available) computing resources capable of being provided are smaller than a threshold may also be excluded from the selection candidates.

Further, it may also be possible to employ a configuration where service types are associated with servers and vehicles in advance, and combinations of the servers and the vehicles are selected according to the service types. Further, it may also be possible to employ a configuration where servers and vehicles 4 are selected in order of their proximity to a target vehicle. The management server 6 stores information on selected servers and vehicles 4 as “resource providers” in an entry for a target vehicle in the management DB 32d, and also stores information indicating a task that is to be executed by the respective servers and the vehicles 4 and the processing time of the task as “processing time” in an entry for the target vehicle.

The management server 6 transmits a task request message to each of the servers and the vehicles 4 selected as the computing resource providers (<5> and <6> in FIG. 5). In the management server 6, the network addresses of the servers and the vehicles 4 are known. The task request message includes information indicating the content of the task (processing), information indicating computing resources for executing the task, task scheduling instructions, or the like. The task request message also includes a designated processing time, making it possible to instruct scheduling so that the execution of the task is completed within the designated processing time. Further, the task request message also includes a destination for the execution result of the task, that is, information indicating a method (such as a destination network address) for transmitting information obtained (generated) through the execution of the task to the target vehicle.

The respective servers having received the task request message perform the scheduling of the requested task according to the instructions in the task request message and execute the task (processing) (<7> in FIG. 5). Then, the respective servers transmit information obtained through the execution of the task (information related to service provision) to the target vehicle as processing results.

Also, the respective vehicles 4 having received the task request message perform the scheduling of the requested task (processing) according to the instructions in the task request message and execute the task (<7> in FIG. 5). Then, the respective vehicles 4 transmit information obtained through the execution of the task (information related to service provision) to the target vehicle as processing results. As an alternative way to the above, the information related to the service provision may also be transmitted to the target vehicle via the management server 6. The target vehicle is allowed to receive the requested service by receiving and using the information related to the service provision.

Each of the servers and the vehicles transmits information (completion report) indicating that the information related to the service provision has been transmitted to the target vehicle to the management server 6 (<11> and <12> in FIG. 5). When receiving the completion report from the vehicles 4 (registered vehicles), the management server 6 transmits information indicating incentives for the users (owners) of the registered vehicles (<13> in FIG. 5). The information indicating the incentives could include, for example, discounts on fees when the users (owners) of the registered vehicles receive services, coupons offering discounts on purchases of items, or the like. However, the details of the incentives are adjustable as needed. The provision of information indicating such incentives is optional.

Further, the management server 6 may also transmit a response message to the service request message to the target vehicle at specified timings, such as when the management server 6 has transmitted the task request message to the servers and the vehicles 4, and when the management server 6 has received the information indicating the transmission of the processing results from the servers and the vehicles 4.

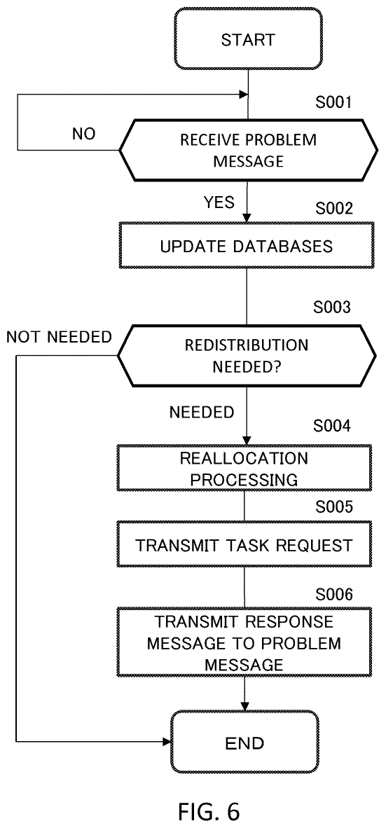

FIG. 6 is a flowchart illustrating a processing example related to the redistribution of computing resources. The processing illustrated in FIG. 6 is performed by (the processor 31 of) the management server 6. In step S001, the management server 6 waits for the reception of a problem message. The problem message is a message indicating a device problem of a server or a vehicle 4 (terminal 5), or a network problem. The problem message includes information indicating a server or a vehicle 4 that is a problem occurring source, information (logs) indicating a time at which a problem occurred, information indicating the type of a problem, or the like.

The transmission source of a problem message is a server or a vehicle 4, or a monitoring device for a server or a vehicle 4. Further, it may also be possible to employ a configuration where the problem message is issued (transmitted) even when a charging state is canceled before a scheduled charging completion time, due to the occurrence of a problem other than a device problem and a network problem, such as when a charging device is removed before the charging of the secondary cell of a vehicle 4 is completed. Alternatively, it may also be possible to employ a configuration where the problem message is issued when it is determined that the suitable execution of a task is unable due to an increased load resulting from exception handling or the like in a server or a vehicle 4. That is, it may also be possible to employ a configuration where computing resources are redistributed (reallocated) on the basis of the usage conditions of the computing resources in a server or a vehicle 4.

In step S002, when receiving the problem message, the management server 6 updates a “status (problem)” in an entry of the server or the vehicle 4 that is the transmission source of the problem message, on the basis of the information indicating the problem occurring source. That is, a corresponding entry of the server in the network DB 32a is updated when the problem message indicating the problem of the server is received, while a corresponding entry of the vehicle 4 in the vehicle DB 32b is updated when the problem message indicating the problem of the vehicle 4 is received.

In step S003, the management server 6 determines whether the redistribution of computing resources is needed. That is, the management server 6 determines whether a problem occurred before the completion of task execution, on the basis of logs contained in the problem message indicating the time at which the problem occurred, as well as a processing time contained in a task request. The time at which the problem occurred indicates the time at which requirements for continuing a computing resource provider were lost, such as due to a device problem, a network problem, and the cancelation of a charging state. If the time at which the problem occurred is earlier than a scheduled task completion time, it is determined that the redistribution is not needed. On the other hand, if the time at which the problem occurred is later than the scheduled task completion time, it is determined that the redistribution of the computing resources (the reallocation of the computing resources to a target vehicle) is needed.

When it is determined in step S003 that the redistribution is not needed, the processing illustrated in FIG. 6 ends. On the other hand, when it is determined that the redistribution is needed, the processing proceeds to step S004.

In step S004, the management server 6 performs reallocation processing. That is, considering the content of the task (the content of the task request) that had been allocated to the problem occurring source, the management server 6 selects a server or a vehicle 4 to substitute for the problem occurring source. At this time, one or two or more servers and vehicles 4 are selected.

In step S005, the management server 6 transmits a task request message to the server or the vehicle 4 selected in step S004. In step S006, the management server 6 transmits a response message to the problem message. Thus, the management server 6 notifies the transmission source of the problem message that the processing corresponding to the problem message has been performed.

In the information processing system according to the embodiment, the management server 6 has the network DB 32a, the vehicle DB 32b, the service DB 32c, and the management DB 32d in the storage device 32, and the computing resources of servers and vehicles 4 (registered vehicles) are collectively managed. The management server 6 collectively manages the computing resources (first computing resources) of one or more vehicles 4 and the computing resources (second computing resources) of respective servers that are computing resources placed within the network 1. Upon receiving a service request message, the management server 6 collects (acquires) information indicating first and second computing resources (<2> in FIG. 5). Then, the processor 31 (control unit) of the management server 6 outputs information indicating computing resources for providing a service to a target vehicle selected from among the first and second computing resources (<4> in FIG. 5). At this time, the vehicles 4 that are in a parked state and in a state where a secondary cell that supplies power to a motor provided in each of the registered vehicles is being charged are treated as registered vehicle and computing resource providers. Thus, a greater number of computing resources from the vehicles 4 that are in a parked and charging state than from vehicles 4 that are in a traveling state may be provided, with the positions of the vehicles 4 stabilized. As a result, it is possible to suitably select computing resources for providing a service to a target vehicle.

The processor 31 (control unit) of the management server 6 may allocate the computing resources (second computing resources) of servers and the computing resources (first computing resources) of registered vehicles as computing resources related to a target vehicle. The processor 31 (control unit) of the management server 6 may select the first computing resources on the basis of each of the charging times (scheduled charging completion times) of one or more vehicles 4 (<4> in FIG. 5). For example, vehicles 4 with later scheduled charging completion times may be selected with priority.

The second computing resources may be selected from at least one among the computing resources of the cloud servers 2, the computing resources of the edge servers 3, and the computing resources of servers (for example, the management server 6) other than the cloud servers 2 and the edge servers 3 (<4> in FIG. 5).

In the embodiment, the second computing resources are an aggregate of computing resources provided in the facilities of a plurality of service providers related to the provision of a service. The processor 31 (control unit) of the management server 6 may determine computing resources that are to be distributed to a target vehicle among the second computing resources, on the basis of a network-related problem monitoring result common to a plurality of service providers (<4> in FIG. 5).

The processor 31 (control unit) of the management server 6 may determine (select) the first and second computing resources that are to be distributed to a target vehicle, according to the usage conditions of collectively-managed computing resources (<4> in FIG. 5, and FIG. 6).

The processor 31 (control unit) of the management server 6 may output information for the owners or users of vehicles 4 (registered vehicles) that provide the first computing resources to a target vehicle (<13> in FIG. 5). Thus, it is possible to prompt the owners or users of the vehicles 4 to provide the vehicles 4 as registered vehicles.

According to the embodiment, it is possible to collectively manage the computing resources of vehicles 4, servers, or the like, optimally distribute a required amount from the collectively-managed computing resources according to a processing amount necessary for a service used by each of the vehicles 4, prevent the over-securing of resources, and reduce costs. Further, compared to a case where a plurality of service providers individually manage computing resources, it is possible to minimize processing loads or the like for switching and connecting computing resources during the occurrence of problems or the like, and improve performance compared to a case where one service provider is utilized.

Further, in the embodiment, monitoring of problems is performed across a plurality of service providers. Further, resource conditions are grasped, making it possible to avoid problems, adjust the optimum distribution of entire processing resources, and achieve the optimization of load dispersion between processing systems. Further, it is possible to realize comprehensive security reservation during the utilization of the computing resources of a plurality of service providers. That is, in the information processing system illustrated in FIG. 1, it is possible to apply comprehensive security measures to servers and vehicles that serve as collectively-managed computing resource providers.

Note that the processing orders in the sequence diagrams and flowcharts in this specification may be changed as long as no contradictions arise.

The processing or means described in this disclosure may be freely combined together for implementation as long as no technological contradictions arise. Further, the processing described as being performed by one device may be borne and performed by a plurality of devices. Alternatively, the processing described as being performed by different devices may be performed by one device. In a computer system, it is possible to flexibly change how respective functions are realized by hardware configurations (server configurations).

This disclosure may also be realized by supplying a computer program with the functions described in the above embodiment to a computer and causing one or more processors provided in the computer to read and run the program. Such a computer program may be provided to a computer via a non-transitory computer-readable storage medium connectable to a computer system bus, or may be provided to a computer via a network. The non-transitory computer-readable storage medium includes, for example, any type of disk such as a magnetic disk (such as a floppy (TM) disk and a Hard Disk Drive (HDD)), any type of disk such as an optical disk (such as a CD-ROM, a DVD disc, and a Blu-ray disc), and any type of medium suitable for storing electronic instructions, such as a Read-Only Memory (ROM), a Random Access Memory (RAM), an EPROM, an EEPROM, a magnetic card, a flash memory, and an optical card.

What is claimed is:

1. An information processing device comprising:
a control unit that acquires information indicating each of a first computing resource and a second computing resource that are collectively-managed computing resources, the first computing resource being provided in each of one or more vehicles, the second computing resource being a computing resource placed within a network, and
outputs information indicating a computing resource for providing a service to a target vehicle, the computing resource being selected from among the first computing resource and the second computing resource, wherein
each of the one or more vehicles is in a parked state and in a charging state where a secondary cell that supplies power to a motor provided in each of the one or more vehicles is being charged.

2. The information processing device according to claim 1, wherein
the control unit allocates the first computing resource and the second computing resource as the computing resources related to the target vehicle.

3. The information processing device according to claim 1, wherein
the control unit selects the first computing resource on a basis of a charging time of each of the one or more vehicles.

4. The information processing device according to claim 1, wherein
the second computing resource is selected from at least one among a computing resource of a cloud server, a computing resource of an edge server, and a computing resource of a server other than the cloud server and the edge server.

5. The information processing device according to claim 1, wherein
the second computing resource is an aggregate of computing resources provided in each of a plurality of service providers related to the provision of the service, and
the control unit determines a computing resource to be distributed to the target vehicle among the second computing resources, on a basis of a network-related problem monitoring result common to the plurality of service providers.

6. The information processing device according to claim 1, wherein
the control unit determines the first computing resource and the second computing resource to be distributed to the target vehicle, according to a usage condition of the collectively-managed computing resources.

7. The information processing device according to claim 1, wherein
the control unit outputs information indicating an incentive for an owner or a user of a vehicle that provides the first computing resource to the target vehicle.

8. An information processing method comprising:
acquiring, by an information processing device, information indicating each of a first computing resource and a second computing resource that are collectively-managed computing resources, the first computing resource being provided in each of one or more vehicles, the second computing resource being a computing resource placed within a network; and
outputting, by the information processing device, information indicating a computing resource for providing a service to a target vehicle, the computing resource being selected from among the first computing resource and the second computing resource, wherein
each of the one or more vehicles is in a parked state and in a charging state where a secondary cell that supplies power to a motor provided in each of the one or more vehicles is being charged.

9. The information processing method according to claim 8, wherein
the information processing device allocates the first computing resource and the second computing resource as the computing resources related to the target vehicle.

10. The information processing method according to claim 8, wherein
the information processing device selects the first computing resource on a basis of a charging time of each of the one or more vehicles.

11. The information processing method according to claim 8, wherein
the second computing resource is selected from at least one among a computing resource of a cloud server, a computing resource of an edge server, and a computing resource of a server other than the cloud server and the edge server.

12. The information processing method according to claim 8, wherein
the second computing resource is an aggregate of computing resources provided in each of a plurality of service providers related to the provision of the service, and
the information processing device determines a computing resource to be distributed to the target vehicle among the second computing resources, on a basis of a network-related problem monitoring result common to the plurality of service providers.

13. The information processing method according to claim 8, wherein
the information processing device determines the first computing resource and the second computing resource to be distributed to the target vehicle, according to a usage condition of the collectively-managed computing resources.

14. The information processing method according to claim 8, wherein
the information processing device outputs information indicating an incentive for an owner or a user of a vehicle that provides the first computing resource to the target vehicle.

15. A non-transitory computer-readable storage medium storing a program that causes a computer to:
acquire information indicating each of a first computing resource and a second computing resource that are collectively-managed computing resources, the first computing resource being provided in each of one or more vehicles, the second computing resource being a computing resource placed within a network; and
output information indicating a computing resource for providing a service to a target vehicle, the computing resource being selected from among the first computing resource and the second computing resource, wherein
each of the one or more vehicles is in a parked state and in a charging state where a secondary cell that supplies power to a motor provided in each of the one or more vehicles is being charged.

16. The non-transitory computer-readable storage medium storing the program according to claim 15, wherein
the computer is caused to allocate the first computing resource and the second computing resource as the computing resources related to the target vehicle.

17. The non-transitory computer-readable storage medium storing the program according to claim 15, wherein
the computer is caused to select the first computing resource on a basis of a charging time of each of the one or more vehicles.

18. The non-transitory computer-readable storage medium storing the program according to claim 15, wherein
the second computing resource is selected from at least one among a computing resource of a cloud server, a computing resource of an edge server, and a computing resource of a server other than the cloud server and the edge server.

19. The non-transitory computer-readable storage medium storing the program according to claim 15, wherein
the second computing resource is an aggregate of computing resources provided in each of a plurality of service providers related to the provision of the service, and
the computer is caused to determine a computing resource to be distributed to the target vehicle among the second computing resources, on a basis of a network-related problem monitoring result common to the plurality of service providers.

20. The non-transitory computer-readable storage medium storing the program according to claim 15, wherein
the computer is caused to determine the first computing resource and the second computing resource to be distributed to the target vehicle, according to a usage condition of the collectively-managed computing resources.
